(19) United States
(12) Patent Application Publication
(10) Pub. No.: US 2016/0172849 A1
(43) Pub. Date: Jun. 16, 2016

(54) ESD/EOS DETECTION

(71) Applicant: Infineon Technologies AG, Neubiberg (DE)

(72) Inventors: Donald DIBRA, Munich (DE); Kai ESMARK, Neuried (DE)

(21) Appl. No.: 14/567,998

(22) Filed: Dec. 11, 2014

(51) Int. Cl. H02H 9/04; H02H 9/00

(52) U.S. Cl. CPC H02H 9/046; H02H 9/005

(57) ABSTRACT

Representative implementations of devices and techniques provide detection of an electrical stress event for an electrical component or system. A detection component may be located near the electrical component or system and be arranged to determine the existence of the electrical stress event. In some implementations, the detection component is arranged to record, count, and/or differentiate the type of the electrical stress event.

### BACKGROUND

Today there is a proliferation of high-technology electrical and electronic components and systems applied into harsh environments, such as automotive applications, aerospace applications, industrial applications, and the like. Some of these high-technology components and systems are integrated into vital portions of the applications, with regard to operation and/or safety. These high-technology components and systems, which continue to become smaller and more transistor-dense, can be subject to electrical stresses (in addition to other stresses) due to the harsh nature of the environment, or due to other causes such as wear, design issues, cable/conductor failures, etc.

Two common forms of electrical stress that an electrical or electronic component or system may encounter within a harsh environment include electrostatic discharge (ESD), also known as static electricity discharge, and electrical over-stress (EOS). An ESD event may include a high voltage (e.g., 2-10 kV) and/or current (e.g., 7-30 A) event over a very short (e.g., 5-100 ns) duration. In contrast, an EOS event may include any overvoltage event that exceeds the maximum voltage rating for the electrical component or system for a longer duration than an ESD event (e.g., from a few microseconds to hours).

In either case, undesired temporary or permanent degradation of performance (e.g., soft failures) or damage/destruction (e.g., hard failures) to the electrical or electronic component or system can result from the electrical stress encountered. Further, the effects of electrical stress on the components or systems can be cumulative, causing malfunction or failure of the components or systems with multiple events over time.

In some cases, high-technology components and systems that are intended for harsh environments may be constructed to withstand certain levels of ESD or EOS events. In those cases, temporary or permanent damage may occur to the components or systems when the electrical stress events are of a greater magnitude and/or last for a longer duration than the stress events the components are designed to withstand. For example, such electrical stress events may be the result of another system or component failure within the application. Further, a greater quantity of electrical stress events may be encountered by the components than they are designed for or capable of withstanding over time.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure.

FIG. 1 is a schematic block diagram of an example circuit, showing a circuit component/system to be protected and an ESD protection device. For example, the diagram of FIG. 1 illustrates an environment wherein the techniques and devices described herein may be implemented, according to various implementations.

FIG. 2 is a schematic block diagram of the circuit of FIG. 1 and includes a capacitive electrical stress detection component, according to an implementation.

FIG. 3 is a schematic block diagram of the circuit of FIG. 1 and includes an inductive electrical stress detection component, according to an implementation.

FIG. 4 is a schematic block diagram of the circuit of FIG. 1 and includes a temperature-based electrical stress detection component, according to an implementation.

FIG. 5 is a schematic block diagram of the circuit of FIG. 1 and includes a magnetic field-based electrical stress detection component, according to an implementation.

FIG. 6 is a schematic block diagram of the circuit of FIG. 1 and includes a combination of electrical stress detection components, including a capacitive electrical stress detection component, according to an implementation.

FIG. 7 is a schematic block diagram of the circuit of FIG. 1 and includes a combination of electrical stress detection components, including an inductive electrical stress detection component, according to an implementation.

FIG. 8 is a schematic block diagram of the circuit of FIG. 7 and includes additional electrical stress detection components and protection components, according to an implementation.

FIG. 9 is a graphical illustration of a waveform that is an output signal of a temperature-based electrical stress detection component, according to an implementation.

FIG. 10 is a graphical illustration of another waveform that is an output signal of a temperature-based electrical stress detection component, according to an implementation.

FIG. 11 is a graphical illustration of a further waveform that is an output signal of a temperature-based electrical stress detection component, according to an implementation.

FIG. 12 is a graphical illustration of a waveform that is an output signal of a capacitive-based electrical stress detection component, according to an implementation.

FIG. 13 is a graphical illustration of a waveform that is an output signal of a capacitive-based electrical stress detection component, according to an implementation.

FIG. 14 is a graphical illustration of a waveform that is an output signal of a capacitive-based electrical stress detection component, according to an implementation.

FIG. 15 is a flow diagram illustrating an example process for detecting an electrical stress event, according to an implementation.

### DETAILED DESCRIPTION

### Overview

Representative implementations of devices and techniques provide detection of an electrical stress event (ESE) experienced by an electrical component or system that is desired to be protected. For example, the electrical component or system may be located in a harsh environment, or may be otherwise subjected to electrical stress events. A detection component may be located near the electrical component or system to be protected and be arranged to determine the occurrence of the electrical stress event (ESE).

In some implementations, the detection component is arranged to record, count, and/or differentiate the type of the ESE detected. For example, the detection component may be arranged to differentiate whether the electrical stress event is an ESD event or an EOS event (or another type of ESE).

In different implementations, the detection component is arranged to detect an ESE based on capacitive coupling, inductive coupling, temperature sensing, magnetic field sensing, and the like, or based on a combination of the above.

In various implementations, the detection component comprises a detection system or arrangement, comprising multiple modules or stages. For example the detection component may include one or more detection modules, as well as one or more recording, counting, or differentiating modules, or the like. In alternate implementations, various combinations of the modules or stages may be combined to form the detection component, based on the electrical stress information desired to be captured and/or the actions to be taken. For example, in one implementation, a detection component is arranged to generate a warning signal when a particular stress event is detected, when a preset quantity of stress events are detected, or the like.

Various implementations and techniques for detecting an ESE are discussed in this disclosure. Techniques and devices are discussed with reference to example devices, circuits, and systems illustrated in the figures. However, this is not intended to be limiting, and is for ease of discussion and illustrative convenience. The techniques and devices discussed herein may be applied to any of various components, circuits, circuit designs, structures, systems, etc., while remaining within the scope of the disclosure.

Implementations are explained in more detail below using a plurality of examples. Although various implementations and examples are discussed here and below, further implementations and examples may be possible by combining the features and elements of individual implementations and examples.

### Example Event Detection

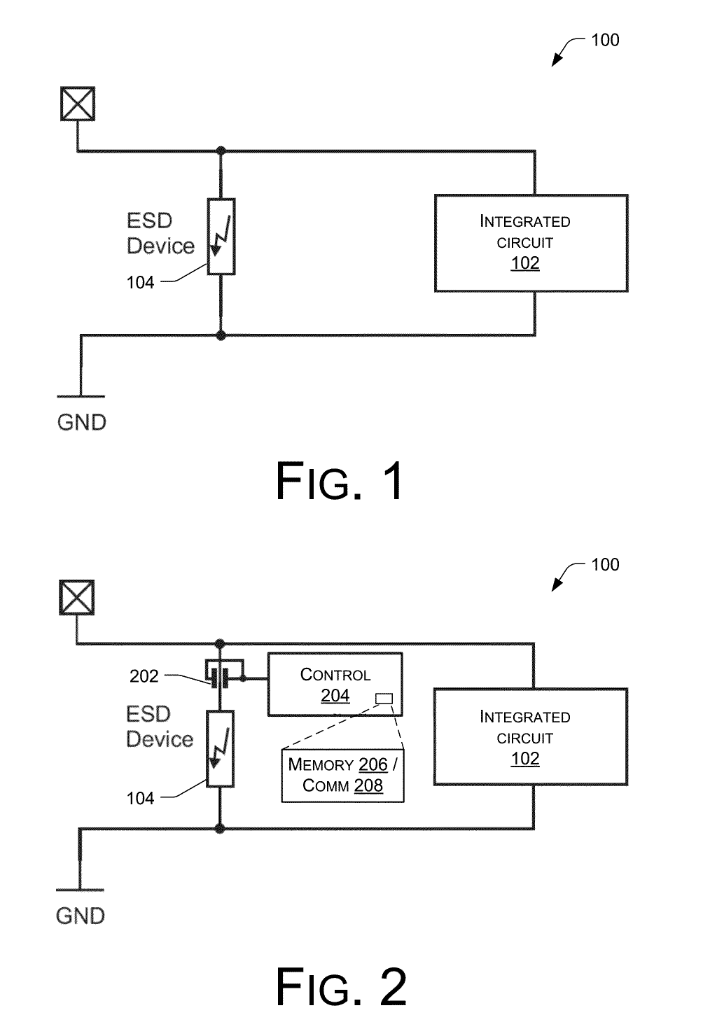

FIG. 1 is a schematic block diagram of an example circuit 100, showing a circuit component/system 102 (“integrated circuit 102”) to be protected and an ESD protection device 104. For example, the diagram of FIG. 1 illustrates an environment wherein the techniques and devices described herein may be implemented, according to various implementations.

The techniques and devices are discussed herein with reference to a component or system to be protected (102). In various implementations, the component or system to be protected (102) can comprise any of various devices, circuits, systems, and so forth, such as integrated circuits (IC), other high-technology electrical or electronic devices, components, or systems, that may be desirable to be protected from potential hazards, such as ESEs, or the like. For ease of discussion and illustrative convenience, any and all components or systems to be protected (102) are referred to herein as “integrated circuit 102” or “IC 102.”

Referring to FIG. 1, in many cases an IC 102 may be protected from electrical stresses, such as ESD events for example, with one or more ESD devices 104. For example, the ESD device 104 may be coupled in parallel to the IC 102 (whether the IC 102 comprises a component, system, circuit, module, etc.) between a conductor that may be susceptible to conducting an ESE (such as a power lead, data lead, etc.) and ground. In an example, the ESD device 104 is arranged to conduct energy of the ESE to ground, and to clamp the voltage between the conductor and ground to a level that is tolerable by the IC 102. In alternate implementations, the ESD device 104 may be positioned between two other conductors, and arranged to clamp the voltage between the two conductors to a level that is tolerable by the IC 102.

In various implementations, the ESD device 104 may comprise any of a variety of clamping or rectifying components (or groups or combinations of components) such as silicon avalanche diodes, silicon rectifiers, metal-oxide varistors, or the like. In the implementations, the ESE is conducted to one terminal of the ESD device 104, and the ESD device 104 changes from a high-impedance state to a very low impedance state when the ESE has a voltage magnitude above a designed threshold. The bulk of the energy of the ESE is conducted through the low-impedance shunt path of the ESD device 104 to ground (or to another conductor), protecting the IC 102 from the energy of the ESE. The voltage of the ESE is clamped by the ESD device 104 to approximately the threshold voltage, and it is the clamped voltage that is experienced by the IC 102.

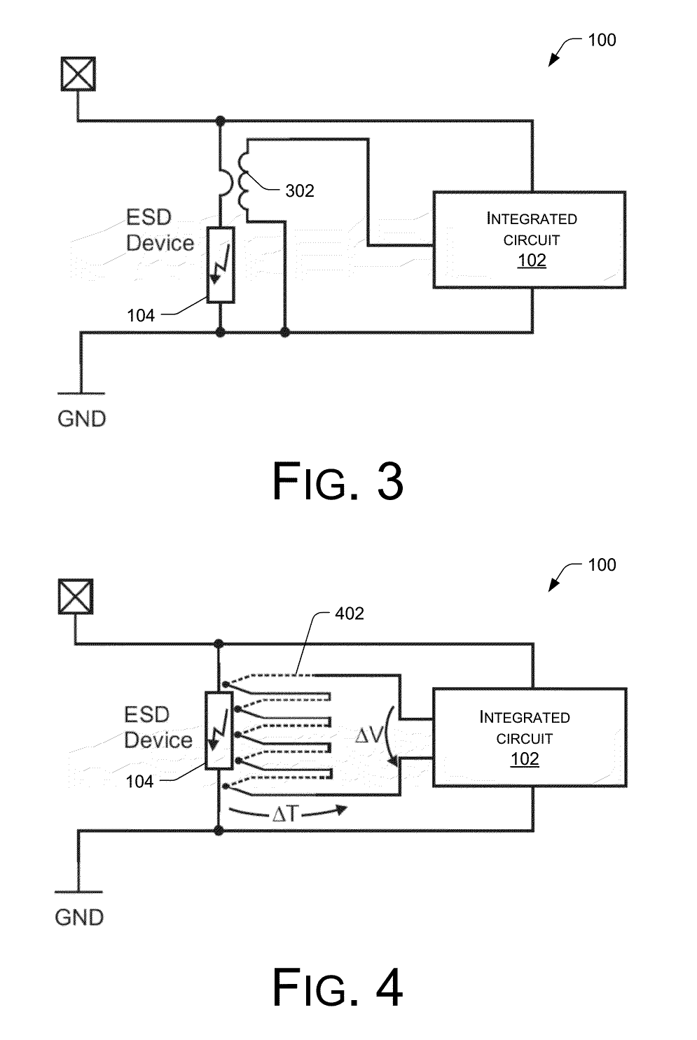

FIG. 2 is a schematic block diagram of the circuit 100 of FIG. 1 and includes a capacitive electrical stress detection component (CDC) 202, according to an implementation. In the implementation, the capacitive CDC 202 is arranged in-line with the shunt path of the ESD device 104. For example, one or more portions of the CDC 202 adjacently border or surround the shunt path. When the ESD device 104 conducts, based on the occurrence of an ESE as described above, then the CDC 202 capacitively detects the current of the ESE on the shunt path, based on the electric field generated by the current, for example.

In an implementation, the CDC 202 also includes a control component 204. In various examples, the control 204 is arranged to record, count, and/or differentiate the type of the ESE detected by the CDC 202. In another example, the control 204 is arranged to analyze the detected ESE, assess the potential stress of the ESE, and/or generate a warning signal based on the ESE (via communication component 208, for instance). For example, the warning signal of the control 204 may be arranged to trigger one or more visual, audible, or data-related alarms or indicators.

In various implementations, the control 204 is arranged to process the detected ESE information, including determining a polarity of the ESE, the energy of the ESE, a pulse duration of the ESE, and so forth. Accordingly, in some implementations, the control 204 includes one or more processors, controllers, or the like. Additionally, the control 204 may include storage capacity in the form of memory 206 and/or communication/networking capabilities via communication component 208.

FIG. 3 is a schematic block diagram of the circuit 100 of FIG. 1 and includes an inductive electrical stress detection component (IDC) 302, according to an implementation. In the implementation, the inductive IDC 302 is arranged in parallel with and adjacent to the shunt path of the ESD device 104. When the ESD device 104 conducts, based on the occurrence of an ESE as described above, then the IDC 302 inductively detects the voltage of the ESE on the shunt path.

In some implementations, the IDC 302 also includes a control component 204, as described above. For example, in various implementations, the control 204 is arranged to record, count, and/or differentiate the type of the ESE detected by the IDC 302, and/or analyze the detected ESE, assess the potential stress of the ESE, and/or generate a warning signal based on the ESE, and/or process the detected ESE information, including determining a polarity of the ESE, the energy of the ESE, a pulse duration of the ESE, and so forth.

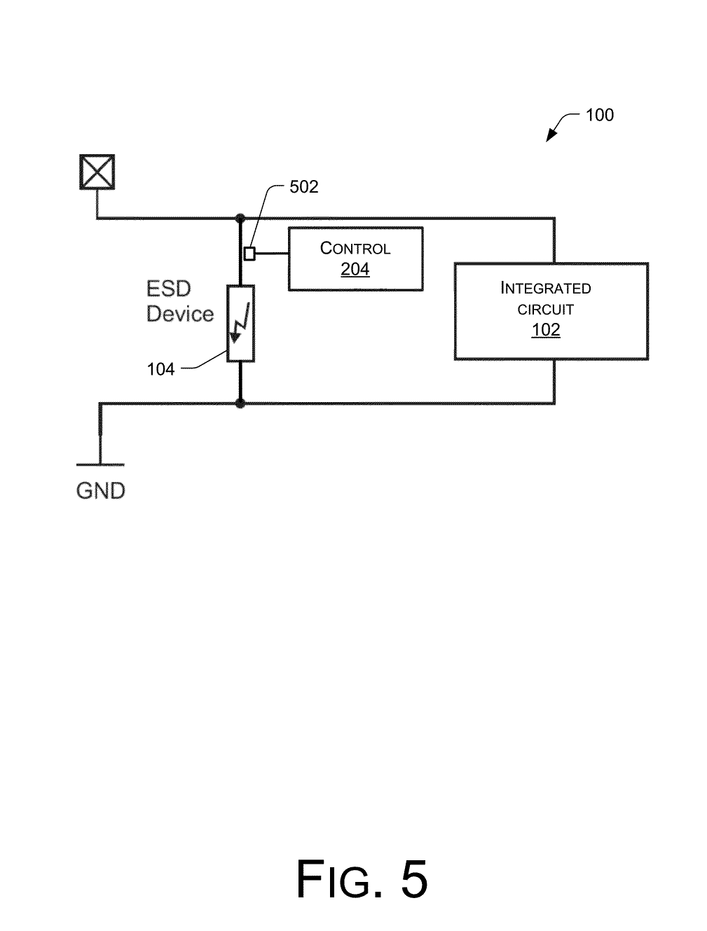

FIG. 4 is a schematic block diagram of the circuit 100 of FIG. 1 and includes a temperature-based electrical stress detection component (TDC) 402, according to an implementation. In the implementation, the temperature-based TDC 402 is arranged in proximity to the ESD device 104 and/or the shunt path of the ESD device 104. When the ESD device 104 conducts, based on the occurrence of an ESE as described above, the ESD device 104 heats due to the conducting and the TDC 402 detects the increase in temperature of the EDS device 104 or near the ESD device 104, indicating the occurrence of the ESE event.

In one example, the TDC 402 comprises a Seebeck sensor, or the like, which is arranged to detect a temperature gradient (ΔT) over a designated length or distance. In the example, the TDC 402 produces an electric field, which can develop a voltage difference (ΔV) across two terminals of the sensor, when the temperature at one end of the sensor, near the low ohmic junction(s) of the sensor (located near the ESD device 104 in the circuit 100 of FIG. 4) is different than the temperature near the other end of the sensor (a specified distance away from the low ohmic junction(s)). The voltage difference can be measured, and can be proportional to the temperature difference, which can indicate properties of the ESE, such as the energy, duration, etc. of the ESE.

In some implementations, the TDC 402 also includes a control component 204, as described above. For example, in various implementations, the control 204 is arranged to record, count, and/or differentiate the type of the ESE detected by the TDC 402, and/or analyze the detected ESE, assess the potential stress of the ESE, and/or generate a warning signal based on the ESE, and/or process the detected ESE information, including determining a polarity of the ESE, the energy of the ESE, a pulse duration of the ESE, and so forth.

FIG. 5 is a schematic block diagram of the circuit 100 of FIG. 1 and includes a magnetic field detection component (MFDC) 502, according to an implementation. In the implementation, the MFDC 502, which is sensitive to a magnetic field, is arranged in proximity to the ESD device 104 and/or the shunt path of the ESD device 104. For example, the MFDC 502 may be located below or above the shunt path and/or the ESD device 104, or in the vicinity of the shunt path and/or the ESD device 104. When the ESD device 104 conducts, based on the occurrence of an ESE as described above, then the MFDC 502 detects the magnetic field resulting from the current flow on the shunt path.

In various examples, the MFDC 502 comprises a Hall device, a GMR (giant magneto-resistive device), an AMR (anisotropic magneto-resistive device), a TMR (tunneling magneto-resistive device), or the like. In one example, the MFDC 502 produces a voltage based on the strength of the detected magnetic field, indicating the occurrence of the ESE event and the magnitude, profile, duration, etc. of the ESE event.

In some implementations, the MFDC 502 also includes a control component 204, as described above. For example, in various implementations, the control 204 is arranged to record, count, and/or differentiate the type of the ESE detected by the MFDC 502, and/or analyze the detected ESE, assess the potential stress of the ESE, and/or generate a warning signal based on the ESE, and/or process the detected ESE information, including determining a polarity of the ESE, the energy of the ESE, a pulse duration of the ESE, and so forth.

### Example Implementations

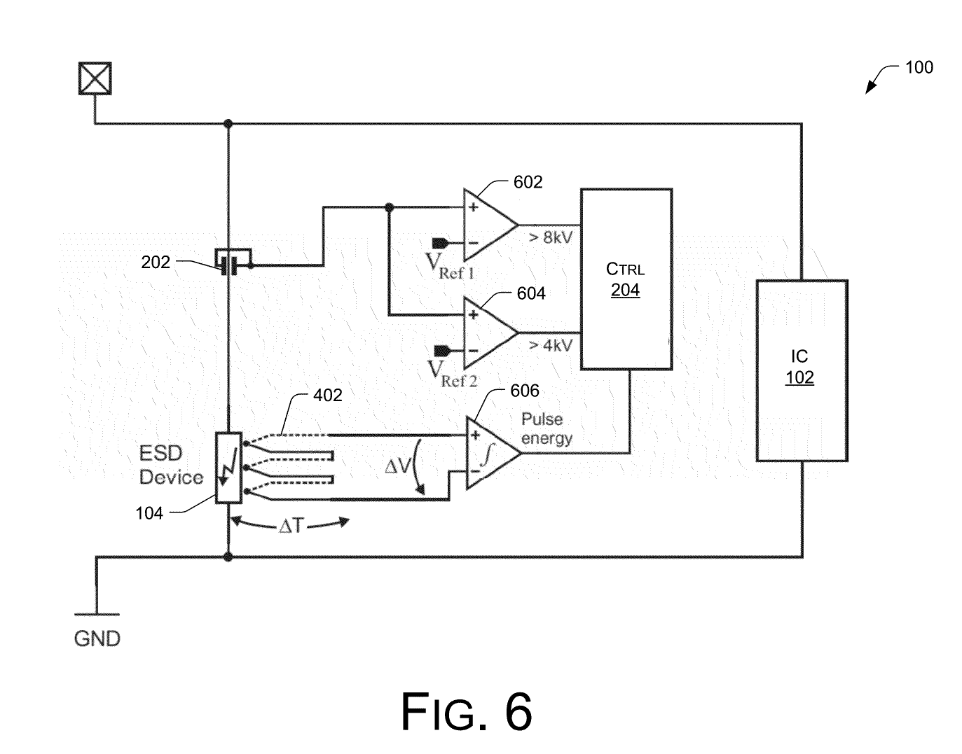

FIG. 6 is a schematic block diagram of the circuit 100 of FIG. 1 and includes a combination of electrical stress detection components, including a capacitive electrical stress detection component 202 and a temperature-based electrical stress detection component 402, according to an implementation. In the implementation, the use of the CDC 202 along with the TDC 402 provides multiple sources of information regarding various ESEs. In various examples, the detection thresholds and/or characteristics of the individual ESE detection components 202, 402 can be arranged so that the combination of ESE detection components 202 and 402 can detect a wide range of ESEs.

For example, in one implementation, the CDC 202 is arranged to detect ESD events and the TDC 402 is arranged to detect EOS events. In such an implementation, the CDC 202 can be arranged to detect short, high magnitude pulses while the TDC 402 can be arranged to detect longer duration over-voltage conditions.

In an implementation, as shown in FIG. 6, the control (CRTL) 204 can be coupled to the CDC 202 and the TDC 402 and arranged to record and/or analyze ESEs detected by each detection component. For example, in various implementations, the control 204 is arranged to count ESD events detected by the CDC 202, determine and classify the magnitude of the ESD events, differentiate between the ESD and EOS events detected, and/or store ESE data in memory 206 (e.g., EEPROM, etc.).

In an example, as shown in FIG. 6, the control 204 may receive signals from the CDC 202 via one or more comparators 602, 604. In one example, the comparators 602, 604 aid in determining the magnitude (and thus a classification) of the ESD events detected by the CDC 202. For instance, the comparator 602 is arranged to compare the voltage of the detected ESD event to a first reference voltage, to determine whether the magnitude of the ESD event exceeded 8 kV, for example. The comparator 604 is arranged to compare the voltage of the detected ESD event to a second reference voltage, to determine whether the magnitude of the ESD event exceeded 4 kV, for example. Thus, the magnitude of the ESD event can be recorded and/or used by the control 204 to classify the detected ESD events by magnitude. In alternate examples, other reference voltages may be used to compare and classify the detected ESD events.

In another example, as shown in FIG. 6, the control 204 may receive signals from the TDC 402 via one or more integrators 606. In the example, the integrator 606 outputs information (e.g., total energy, pulse amplitude, duration, etc.) regarding the energy of a detected EOS event to the control 204, for storage, reporting, counting, classification, or the like. In an implementation, should the IC 102 become damaged or destroyed, the information stored in the memory 206 of the control 204 can be used forensically to investigate the cause of the damage.

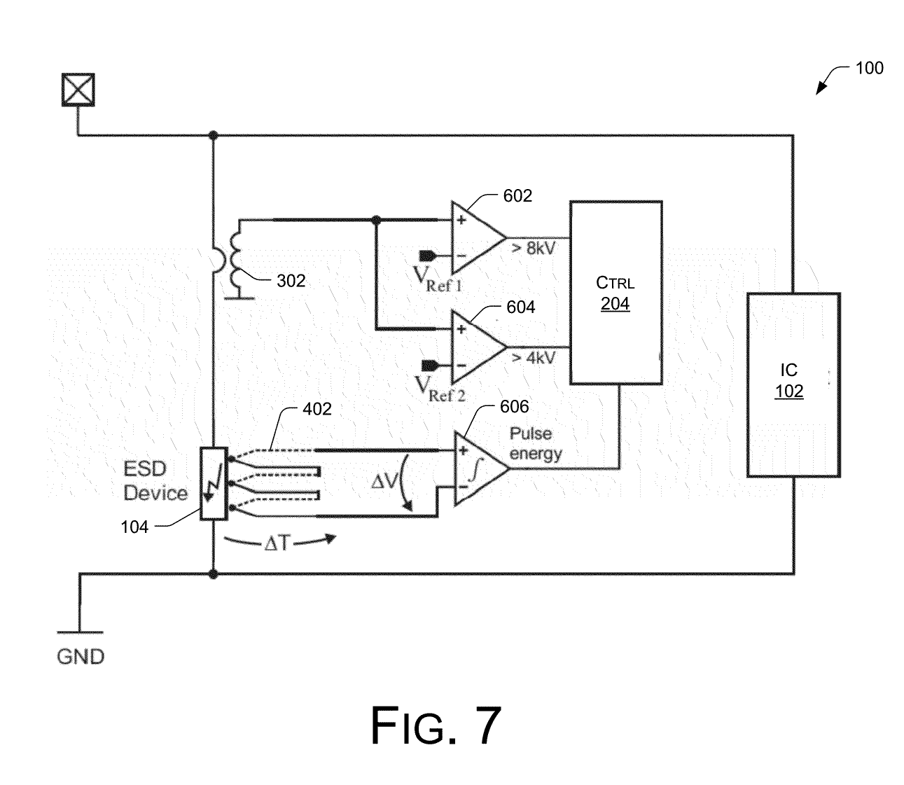

FIG. 7 is a schematic block diagram of an implementation of the circuit 100 as described with reference to FIG. 6, and includes an inductive electrical stress detection component (IDC) 302 in place of the CDC 202 of FIG. 6, according to one example. For example, the IDC 302 is arranged to detect short, high magnitude pulses while the TDC 402 is arranged to detect longer duration over-voltage conditions. In other implementations, a MFDC 502 may be used in place, or in addition to, the CDC 202 or the IDC 302.

In the example of FIG. 7, the control 204 receives signals from the IDC 302 via the comparators 602 and 604, and processes, analyzes, records, reports, etc., in like manner as described above. In alternate implementations, the circuit 100 may include a CDC 202, an IDC 302, a MFDC 502, and a TDC 402 to detect various ESEs. In such implementations, additional comparators, such as 602, 604 may be used for the CDC 202 and the IDC 302, as described above.

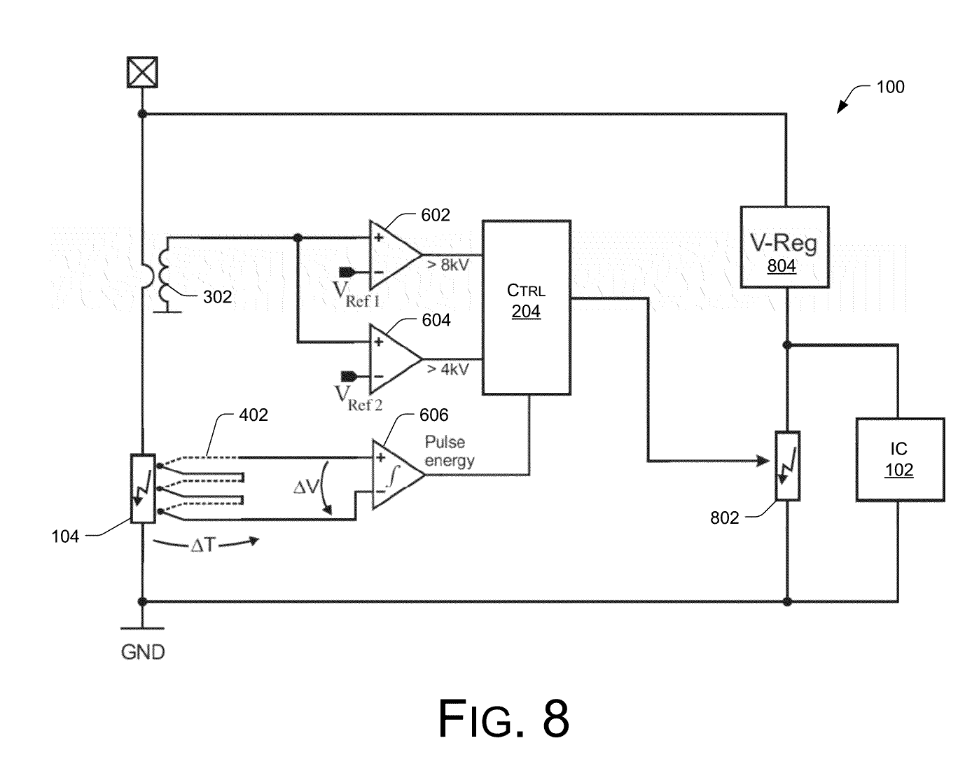

FIG. 8 is a schematic block diagram of the circuit 100 as described with reference to FIG. 7, and includes additional electrical stress detection components and protection components, according to an implementation. For example, in the implementation, the control 204 is arranged to use the information received from the IDC 302 and/or the TDC 402 regarding the occurrence of one or more ESEs to trigger additional detection and/or protection components (e.g., 802, 804) to protect other portions of the circuit 100.

As shown in FIG. 8, an output from the control 204 may be received by an additional ESD device 802, triggering the ESD device 802 to activate and protect the IC 102. For example, the ESD device 802 may become conductive when receiving a trigger signal from the control 204, and clamp the voltage at the protected nodes of the IC 102. While the illustration of FIG. 8 includes two ESD devices (104 and 802), in various implementations, any quantity of ESD devices may be deployed, and any subset of the ESD devices may be triggered by the control 204, or the like.

Referring to FIG. 8, in an implementation, the circuit 100 may also include a voltage regulation component 804 arranged to regulate a voltage to the IC 102. For example, the voltage regulation component 804 regulates and maintains a practically consistent and regular voltage to the IC 102, without regard to the quality of the input voltage to the voltage regulation component 804. However, should a fast transient voltage pulse, as described above with regard to an ESD event, be conducted through the voltage regulation component 804, the additional ESD device 802 can clamp the pulse, conducting the bulk of the energy of the pulse to ground (or other selected conductor) and limiting the magnitude of the pulse that reaches the IC 102 to a level that the IC 102 can tolerate.

In alternate implementations, a circuit 100 may be arranged in various other layouts, having additional ESD devices and/or electrical stress detection components, while fulfilling the functions as described, according to various associated techniques.

### Example Waveforms

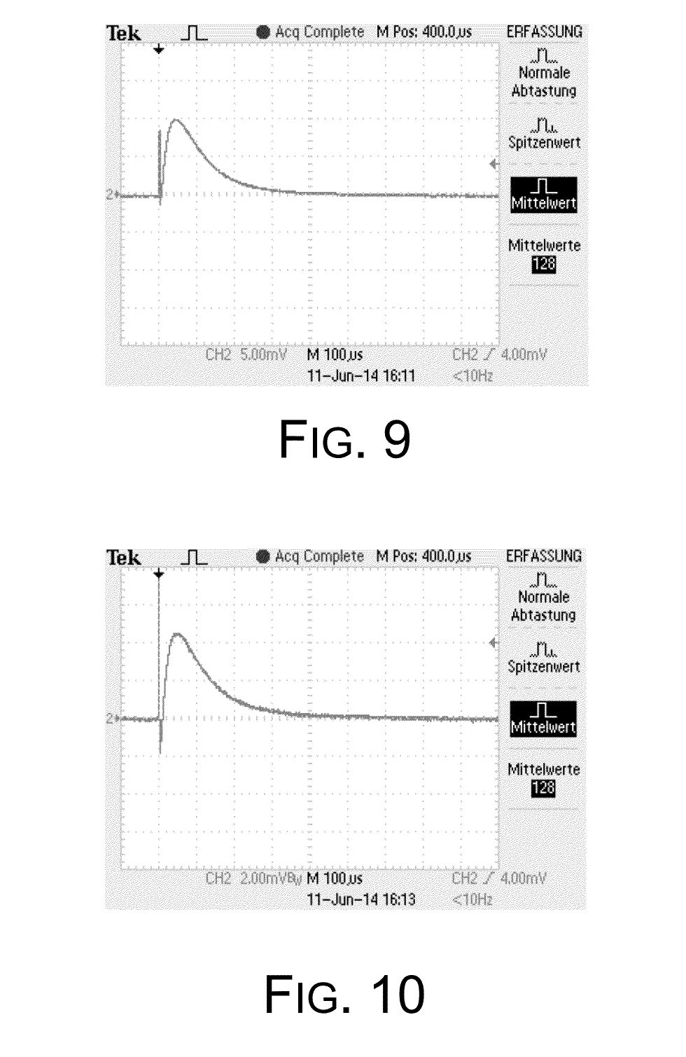

According to various implementations of the circuit 100, having one or more electrical stress detection components 202, 302, 402, 502, the following figures illustrate example signal response waveforms as indicated. The illustrations of FIGS. 9-14 are not intended to be limiting, however. In alternate implementations, a circuit 100 having the described electrical stress detection components 202, 302, 402 and/or 502 may generate different signal waveforms, based on the input signals and the circuit 100 elements.

FIG. 9 is a graphical illustration of an example waveform that is output from the TDC 402 of the circuit 100 of FIG. 4, when a rectangular EOS pulse with 2 μs duration and 1 A peak current is applied on the ESD protection device 104. In the illustration, the example waveform includes a peak pulse of approximately 10 mV, which corresponds to the voltage difference (ΔV) shown in FIG. 4. In an implementation, the 10 mV pulse can be correlated to an energy value of the EOS event for recording, analysis, and the like, as discussed above.

FIG. 10 is a graphical illustration of an example waveform that is output from the TDC 402 of the circuit 100 of FIG. 4, when a rectangular EOS pulse with 1 μs duration and 1 A peak current is applied on the ESD protection device 104. In the illustration, the example waveform includes a peak pulse of approximately 4.5 mV, which corresponds to the voltage difference (ΔV) shown in FIG. 4. In an implementation, the 4.5 mV pulse can be correlated to an energy value of the EOS event for recording, analysis, and the like, as discussed above.

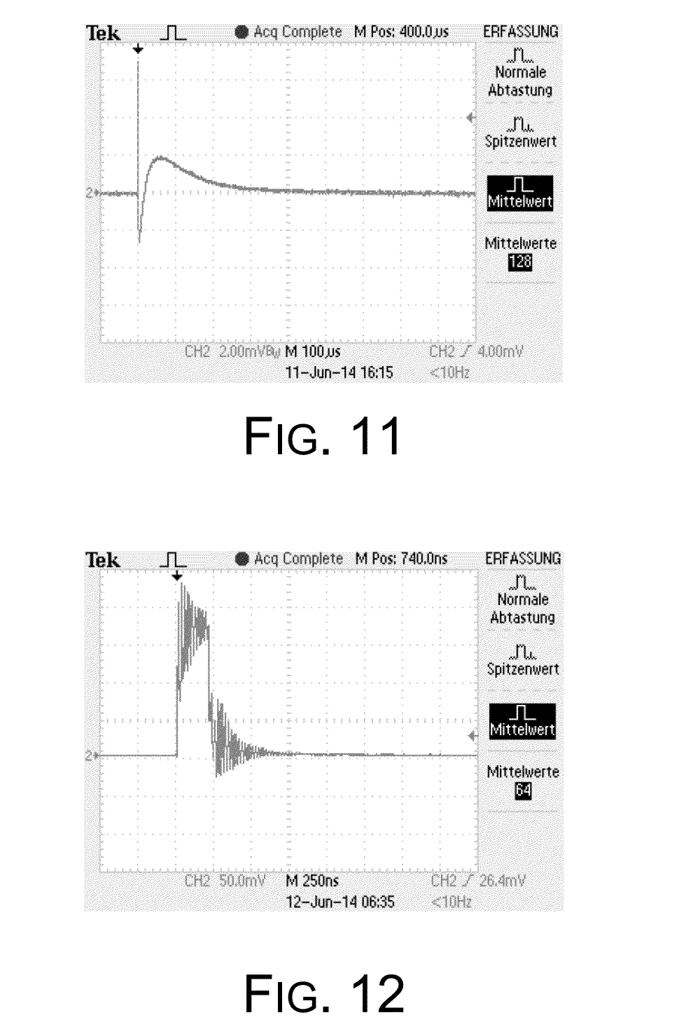

FIG. 11 is a graphical illustration of an example waveform that is output from the TDC 402 of the circuit 100 of FIG. 4, when a rectangular EOS pulse with 500 ns duration and 1 A peak current is applied on the ESD protection device 104. In the illustration, the example waveform includes a peak pulse of approximately 2 mV, which corresponds to the voltage difference (ΔV) shown in FIG. 4. In an implementation, the 2 mV pulse can be correlated to an energy value of the EOS event for recording, analysis, and the like, as discussed above.

For example, using the results of the EOS pulses discussed with respect to FIGS. 9-11, a correlation can be made between the EOS pulse duration and the voltage amplitude of the resulting pulse. In the example, the voltage amplitude of a detected pulse can be used to approximate (as well as record, classify, analyze, etc.) the duration of various EOS events over a range of possible values. In alternate implementations, similar correlations can be made with regard to the peak current, the total energy, and so forth, of the EOS event, for recording, classifying, analyzing, etc. EOS events.

FIG. 12 is a graphical illustration of an example waveform that represents a capacitively coupled signal captured by the CDC 202 of the circuit 100 of FIG. 2, when a rectangular ESD pulse with 200 ns duration and 1 A peak current is applied on the ESD protection device 104. In the illustration, the example waveform includes a peak pulse of approximately 200 mV with 200 ns duration, which information can be received by the control 204 and/or stored in the memory 206. In an implementation, the 200 ns duration can be correlated to an energy value of the ESD event for recording, analysis, signaling by the communication/networking component 208, and the like, as discussed above.

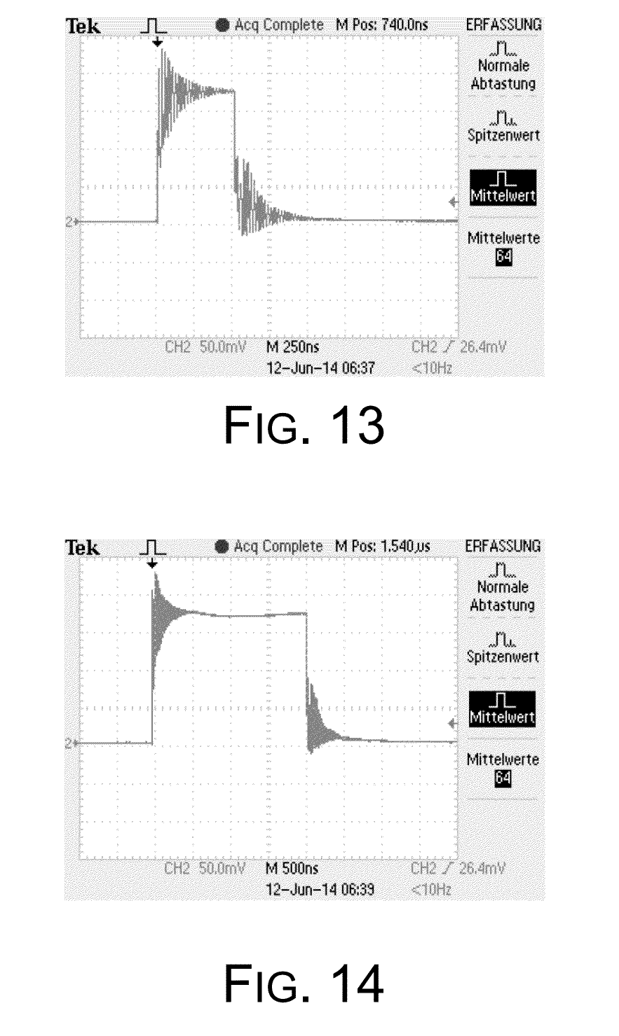

FIG. 13 is a graphical illustration of an example waveform that represents a capacitively coupled signal captured by the CDC 202 of the circuit 100 of FIG. 2, when a rectangular ESD pulse with 500 ns duration and 1 A peak current is applied on the ESD protection device 104. In the illustration, the example waveform includes a peak pulse of approximately 200 mV with 500 ns duration, which information can be received by the control 204 and/or stored in the memory 206. In an implementation, the 500 ns duration pulse can be correlated to an energy value of the ESD event for recording, analysis, signaling by the communication/networking component 208, and the like, as discussed above.

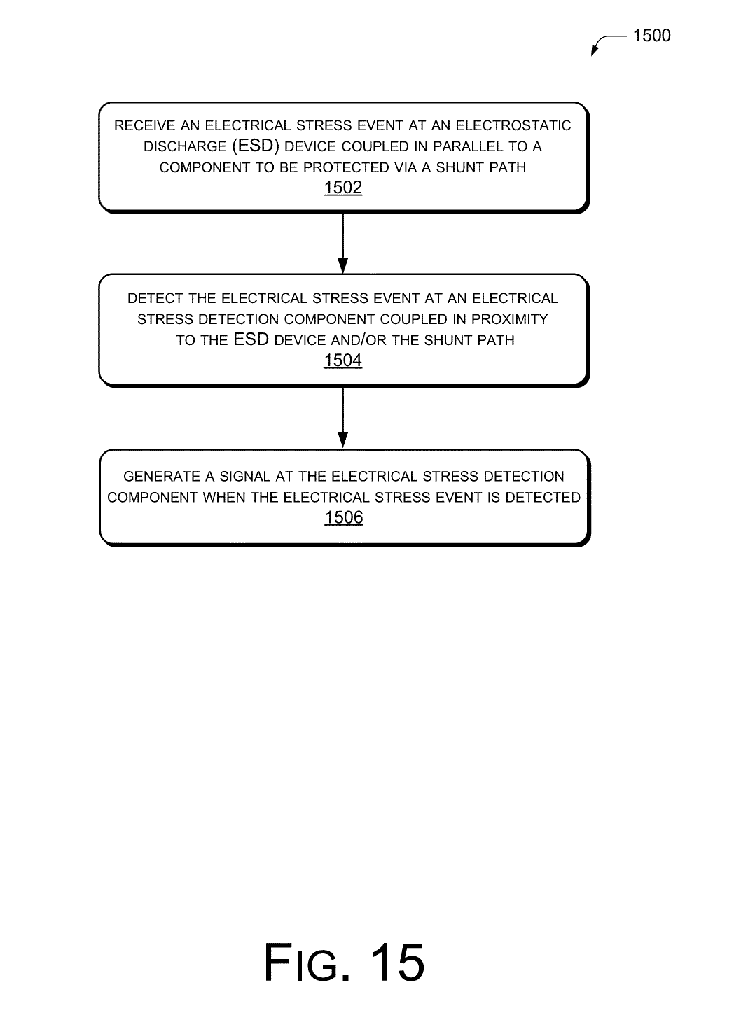

FIG. 14 is a graphical illustration of an example waveform that represents a capacitively coupled signal captured by the CDC 202 of the circuit 100 of FIG. 2, when a rectangular ESD pulse with 2 μs duration and 1 A peak current is applied on the ESD protection device 104. In the illustration, the example waveform includes a peak pulse of approximately 200 mV with 2 μs duration, which information can be received by the control 204 and/or stored in the memory 206. In an implementation, the 2 μs duration pulse can be correlated to an energy value of the ESD event for recording, analysis, signaling by the communication/networking component 208, and the like, as discussed above.

For example, using the results of the ESD pulses discussed with respect to FIGS. 12-14, a correlation can be made between the ESD pulse duration and the duration of the resulting pulse. In the example, the duration of a detected pulse can be used to approximate (as well as record, classify, analyze, etc.) the duration of various ESD events over a range of possible values. In alternate implementations, similar correlations can be made with regard to the peak amplitude (voltage and/or current), the total energy, and so forth, of the ESD event, for recording, classifying, analyzing, etc. ESD events.

The techniques, components, and devices described herein with respect to the example circuit 100 and/or the electrical stress detection components 202, 302, 402, 502 are not limited to the illustrations of FIGS. 2-8, and may be applied to other circuits, structures, devices, and designs without departing from the scope of the disclosure. In some cases, additional or alternative components may be used to implement the techniques described herein. Further, the components may be arranged and/or combined in various combinations, while remaining within the scope of the disclosure. It is to be understood that an electrical stress detection component 202, 302, 402, 502, or the like, may be implemented as a stand-alone device or as part of another system (e.g., integrated with other components, systems, etc.).

### Representative Process

FIG. 15 is a flow diagram illustrating an example process 1500 for detecting an electrical stress event (ESE), according to an implementation. The process 1500 describes using one or more detection components (such CDC 202, IDC 302, TDC 402, and/or MFDC 502 for example) to detect the occurrence of an ESE. In some implementations, a control component (such as control 204, for example) may be arranged to receive a signal from the detection component(s) and record, store, analyze, classify, differentiate, etc. ESEs based on the signals received. The process 1500 is described with reference to FIGS. 1-14.

The order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, the process can be implemented in any suitable materials, or combinations thereof, without departing from the scope of the subject matter described herein.

At block 1502, the process includes receiving an electrical stress event (such as an ESD or EOS, for example) at an electrostatic discharge (ESD) device (such ESD device 104, for example). In an implementation, the ESD is coupled in parallel to a component to be protected (such as IC 102, for example) via a shunt path.

At block 1504, the process includes detecting the electrical stress event at an electrical stress detection component (such as electrical stress detection component 202, 302, 402, or 502, for example) coupled in proximity to the ESD device and/or the shunt path. In various implementations, the electrical stress detection component is coupled adjacent to or in the vicinity of (or at least partially surrounding, in the case of a capacitive electrical stress detection component) the ESD device and/or the shunt path to detect indications of the electrical stress event based on the activation of the ESD device. In some implementations, multiple electrical stress detection components are employed concurrently.

At block 1506, the process includes generating a signal (such as the signals shown in FIGS. 9-14, for example) at the electrical stress detection component when the electrical stress event is detected. In implementations having multiple electrical stress detection components, each electrical stress detection component generates a signal.

In an implementation, the process includes receiving the signal(s) at a control component (such as control 204, for example). In an implementation, the process further includes analyzing the signal(s) for properties of the electrical stress event and recording the properties of the electrical stress event. In one implementation, the process includes differentiating whether the electrical stress event is an electrostatic discharge (ESD) event or an electrical over-stress (EOS) event at the control component. For example, this may be based on the signal(s) received by the control component.

In an implementation, the process includes storing electrical stress event information at a memory storage component (such as memory 206, for example) of the electrical stress detection component. In an implementation, the electrical stress event information is retrievable from the memory storage component for forensic investigation and analysis, for example.

In an implementation, the process includes generating a warning signal at a communication component (such as communication component 208, for example) of the electrical stress detection component. In an implementation, the warning signal is based on properties of the electrical stress event. For example, the warning signal may be based on an energy level, a voltage or current magnitude, or a duration of the electrical stress event, or the like, or it may be based on a quantity of electrical stress events counted, or other properties and/or characteristics of detected electrical stress events.

In an implementation, the process includes receiving the signal at one or more comparators coupled to the electrical stress detection component. In the implementation, the process includes comparing a voltage of the signal to one or more reference voltages and classifying the electrical stress event based on the comparing. In one implementation, the process includes receiving the signal at an integrator coupled to the electrical stress detection component. In the implementation, the process includes outputting an energy value of the electrical stress event to a control component and processing the energy value at the control component.

In an implementation, the process includes sending a trigger to activate one or more additional ESD devices based on detecting the electrical stress event at the electrical stress detection component. For example, the control may generate the trigger based on signals received at the control. In other examples, the trigger may be generated at one or more other components (such as the electrical stress detection component, a comparator, etc.)

In an implementation, the process includes correlating properties of the signal to properties of the electrical stress event, and approximating characteristics of future detected electrical stress events based on the correlating. For example, correlations between a magnitude or duration of an electrical stress event and a magnitude or duration of a signal generated by an electrical stress detection component may be determined and used for analysis, approximation, classification, and so forth, of subsequent electrical stress events.

In alternate implementations, other techniques may be included in the process in various combinations, and remain within the scope of the disclosure.

### CONCLUSION

Although the implementations of the disclosure have been described in language specific to structural features and/or methodological acts, it is to be understood that the implementations are not necessarily limited to the specific features or acts described. Rather, the specific features and acts are disclosed as representative forms of implementing example devices and techniques.

What is claimed is:

1. An apparatus, comprising:
an electrostatic discharge (ESD) device arranged to be coupled in parallel to a component to be protected via a shunt path; and
an electrical stress detection component coupled in proximity to the ESD device and/or the shunt path, and arranged to generate a signal when an electrical stress event is detected.

2. The apparatus of claim 1, further comprising a control component arranged to receive the signal and to record the electrical stress event and/or differentiate whether the electrical stress event is an electrostatic discharge (ESD) event or an electrical over-stress (EOS) event.

3. The apparatus of claim 2, wherein the control component is arranged to: count the electrical stress event, analyze the electrical stress event, assess the potential stress of the electrical stress event, determine a polarity of the electrical stress event, determine an energy value of the electrical stress event, and/or determine a pulse duration of the electrical stress event.

4. The apparatus of claim 1, further comprising a communication component arranged to generate a warning signal when the electrical stress event is detected or when a preset quantity of electrical stress events is detected.

5. The apparatus of claim 1, further comprising a memory storage component arranged to store information regarding detected electrical stress events, which may be retrieved and analyzed.

6. The apparatus of claim 1, wherein the electrical stress detection component comprises a capacitive electrical stress detection component (CDC) arranged to detect a current on the shunt path when the ESD device conducts, one or more portions of the CDC adjacently border or surround the shunt path.

7. The apparatus of claim 1, wherein the electrical stress detection component comprises an inductive electrical stress detection component (IDC) arranged to detect a voltage on the shunt path when the ESD device conducts, the IDC arranged in parallel with and adjacent to the shunt path.

8. The apparatus of claim 1, wherein the electrical stress detection component comprises a magnetic field detection component (MFDC) arranged to detect a magnetic field proximate to the shunt path when the ESD device conducts, the MFDC arranged below, above, or in the vicinity of the shunt path.

9. The apparatus of claim 1, wherein the electrical stress detection component comprises a temperature-based electrical stress detection component (TDC) arranged to detect an increase in temperature of the ESD device or near the ESD device when the ESD device conducts, the TDC arranged in proximity to the ESD device.

10. The apparatus of claim 9, wherein the TDC comprises a Seebeck sensor device arranged to detect a temperature gradient over a designated distance, and to output a voltage difference between two terminals of the sensor device based on the temperature gradient.

11. An electrical circuit, comprising:
an electrostatic discharge (ESD) device arranged to be coupled in parallel to a component to be protected via a shunt path;
an electrical stress detection component coupled in proximity to the ESD device and/or the shunt path, and arranged to generate a signal when an electrical stress event is detected;
one or more comparators coupled to the electrical stress detection component and arranged to receive the signal and to determine properties of the electrical stress event; and
a control component arranged to receive and to record the properties of the electrical stress event from the one or more comparators.

12. The electrical circuit of claim 11, further comprising an integrator coupled to the electrical stress detection component and arranged to receive the signal and to output an energy value of the electrical stress event to the control component.

13. The electrical circuit of claim 11, further comprising one or more additional ESD devices arranged to protect the component to be protected from an electrical stress event, and arranged to be activated based on the electrical stress detection component generating the signal.

14. The electrical circuit of claim 11, wherein the one or more comparators are arranged to compare the electrical stress event to one or more reference voltages and to determine a magnitude classification of the electrical stress event based on the comparison.

15. The electrical circuit of claim 11, wherein the control component includes a memory component arranged to store electrical stress event information and/or a communication component arranged to generate a warning signal based on the electrical stress event information.

16. The electrical circuit of claim 11, wherein the control component is arranged to differentiate whether the electrical stress event is an electrostatic discharge (ESD) event or an electrical over-stress (EOS) event.

17. A method, comprising:
receiving an electrical stress event at an electrostatic discharge (ESD) device coupled in parallel to a component to be protected via a shunt path;
detecting the electrical stress event at an electrical stress detection component coupled in proximity to the ESD device and/or the shunt path; and
generating a signal at the electrical stress detection component when the electrical stress event is detected.

18. The method of claim 17, further comprising receiving the signal at a control component; analyzing the signal for properties of the electrical stress event; and recording the properties of the electrical stress event.

19. The method of claim 18, further comprising differentiating whether the electrical stress event is an electrostatic discharge (ESD) event or an electrical over-stress (EOS) event at the control component.

20. The method of claim 17, further comprising storing electrical stress event information at a memory storage component of the electrical stress detection component, the electrical stress event information being retrievable from the memory storage component for forensic investigation and analysis.

21. The method of claim 17, further comprising generating a warning signal at a communication component of the electrical stress detection component, the warning signal based on properties of the electrical stress event.

22. The method of claim 17, further comprising receiving the signal at one or more comparators coupled to the electrical stress detection component; comparing a voltage of the signal to one or more reference voltages; and classifying the electrical stress event based on the comparing.

23. The method of claim 17, further comprising receiving the signal at an integrator coupled to the electrical stress detection component; outputting an energy value of the electrical stress event to a control component; and processing the energy value at the control component.

24. The method of claim 17, further comprising sending a trigger to activate one or more additional ESD devices based on detecting the electrical stress event at the electrical stress detection component.

25. The method of claim 17, further comprising correlating properties of the signal to properties of the electrical stress event, and approximating characteristics of future detected electrical stress events based on the correlating.

26. An electrical stress event detection circuit, comprising:
an electrostatic discharge (ESD) device arranged to be coupled in parallel to a component to be protected via a shunt path;
at least two electrical stress detection components coupled in proximity to the ESD device and/or the shunt path, each arranged to generate a signal when an electrical stress event is detected;
one or more comparators coupled to a first electrical stress detection component and arranged to receive a first signal and to determine a voltage classification of the electrical stress event based on the first signal;
an integrator coupled to a second electrical stress detection component and arranged to receive a second signal and to output an energy value of the electrical stress event; and
a control component arranged to receive and to analyze an output of the one or more comparators and an output of the integrator, and to record properties of the electrical stress event based on the analysis.
